(19) United States
(12) Patent Application Publication
(10) Pub. No.: US 2025/0078095 A1
(43) Pub. Date: Mar. 6, 2025

(54) AGENTIC BASED PROCESSING FOR CARBON EMISSIONS AUDITING

(71) Applicant: Schlumberger Technology Corporation, Sugar Land, TX (US)

(72) Inventors: Sunil Manikani, Pune (IN); Vishwanath Sule, Pune (IN); Abbi Moghaiyera Hassan, Houston, TX (US); Paul Milne, Aberdeen (GB)

(21) Appl. No.: 18/817,778

(22) Filed: Aug. 28, 2024

Related U.S. Application Data
(60) Provisional application No. 63/579,277, filed on Aug. 28, 2023.

(51) Int. Cl. G06Q 30/018

(52) U.S. Cl. CPC G06Q 30/018

(57) ABSTRACT

Carbon emission auditing includes obtaining a supplier transaction record of an enterprise corresponding to a supplier entity from a transaction repository. A research response corresponding to the supplier entity is obtained from a large language model (LLM). A validity of the supplier transaction record based on the research response is further obtained from the LLM as a validation response. Field values of the record fields of the supplier transaction record are further verified by the LLM, and a resulting consistency response is generated. The LLM further determines an audit of the supplier transaction record based on the research response, the validation response and the consistency response. An explanation of the occurrence of an audit failure is generated by the LLM. The supplier transaction record is further modified, and a new scope emission category necessitated by the modification is assigned to the supplier transaction record.

### CROSS REFERENCE TO RELATED APPLICATIONS

This application is a non-provisional application of, and thereby claims benefit under 35 U.S.C. § 119(e), to U.S. Provisional Application Ser. No. 63/579,277 filed on Aug. 28, 2023, which is incorporated herein by reference.

### BACKGROUND

Carbon auditing is a tool used to assess the carbon footprint of various products and services offered by a business, government, or non-profit entity. Carbon auditing aids in the identification of opportunities for emission reductions. For an entity, different scopes of carbon emissions are considered in the carbon emission auditing process.

The Greenhouse Gas (GHG) Protocol scope classifications refer to the diverse levels of GHG emissions that an organization or entity can account for when measuring and reporting their carbon emissions. The GHG Protocol is a widely recognized accounting tool developed by the World Resources Institute (WRI) and the World Business Council for Sustainable Development (WBCSD) to standardize GHG emissions accounting and reporting. The GHG Protocol identifies three scope classifications, commonly known as Scope 1, Scope 2, and Scope 3 emissions. These scopes help organizations understand and categorize their emission sources, enabling them to develop comprehensive emission reduction strategies.

Scope 1 emissions are direct emissions. Direct emissions refer to the emissions resulting from direct actions of the entity. For example, the direct emissions include the operations of the entity facilities and the vehicles.

Scope 2 emissions are one level of indirection, such as purchased electricity, steam, heating and cooling, and other causes of carbon emissions. When an entity consumes electricity, for example, it indirectly contributes to the emissions associated with the electricity generation.

Scope 3 emissions are from upstream or downstream activities. For example, upstream activities include goods, purchased goods and services, transportation and distribution of goods, business travels, etc. Scope 3 activities can be difficult to track because the target entity generally does not have visibility in how upstream and downstream companies are performing operations to obtain accurate measures of the carbon emissions caused by the target entity. Thus, for scope 3 indirect carbon emission auditing, a carbon emission factor database is used that relates hierarchically defined categories of expenses to emission factors. The emission factors may then be applied to the expense records to estimate scope 3 carbon emissions of an entity.

The application of the emission factors is often a manual implementation, prone to errors. With millions of transaction records, the categorization of the transaction records and the corresponding emission factors applied may be prone to error. Moreover, error detection is a challenge. Undetected errors may compound exponentially, leading to miscalculation of emissions at an exceptionally large scale. Auditing transactions with respect to the carbon emission factors is an intervention for accurate reporting of emission sources. General carbon auditing methods often involve time-consuming and expensive manual processes and are also prone to errors.

Furthermore, it is practically unfeasible to rely on manual effort in extracting, accurately categorizing, and interpreting emissions data from exponentially growing, unstructured, and unclassified enterprise data. Other natural language processing approaches require manual intervention at least to a basic degree. Manual intervention is a limitation on scale of processing emissions data. A technical challenge arises in developing a machine-based solution at scale to automatically audit transaction records based on natural language processing. Natural language processing entails auditing transaction records considering the semantic meaning and implications of record field values. The semantic meaning of the record fields informs the audit of the transaction records, and further corrections.

### SUMMARY

In general, carbon emission auditing includes obtaining a supplier transaction record of an enterprise corresponding to a supplier entity from a transaction repository. A research response corresponding to the supplier entity is obtained from a large language model (LLM). A validity of the supplier transaction record based on the research response is further obtained from the LLM as a validation response. Field values of the record fields of the supplier transaction record are further verified by the LLM, and a resulting consistency response is generated. The LLM further determines an audit of the supplier transaction record based on the research response, the validation response and the consistency response. If the audit fails, an explanation of the audit failure is generated by the LLM. The supplier transaction record may further be modified, and a new scope emission category necessitated by the modification may be assigned to the supplier transaction record.

Other aspects of one or more embodiments will be apparent from the following description and the appended claims.

### BRIEF DESCRIPTION OF DRAWINGS

FIG. 1 shows a diagram of a system in accordance with one or more embodiments.

FIG. 2 and shows a flowchart in accordance with one or more embodiments.

FIG. 3 shows a flowchart in accordance with one or more embodiments.

FIG. 4 and FIG. 5 show example diagrams in accordance with one or more embodiments.

FIG. 6A and FIG. 6B show a computing system in accordance with one or more embodiments.

Like elements in the various figures are denoted by like reference numerals for consistency.

### DETAILED DESCRIPTION

In general, embodiments are directed to large language model-based emission auditing by a carbon emission auditor. The carbon emission auditor includes multiple large language model (LLM) agents. The LLM agents use a LLM as a central computational engine to streamline and expedite carbon auditing procedures. The LLM agents interact in a multilevel auditing workflow that automatically audits, in parallel, thousands of transaction records. The multilevel auditing workflow is an agentic workflow. At a first level, a researching LLM agent invokes the LLM to research the corresponding supplier entity of the transaction and obtain research data. At a second level, a validation LLM agent invokes the LLM to perform a validity analysis on the transaction record to determine any misalignment between the transaction data and the research data. At the second level, a consistency LLM agent invokes the LLM to check whether the transaction record with the included categorization and carbon emission factor is internally consistent. At the third level, a consolidation LLM agent consolidates the output of the validation LLM agent and the consistency LLM agent. If the consolidation LLM agent determines that the emission category is incorrect, the consolation LLM agent may invoke a rephrasing LLM agent and a reassigning LLM agent to update the transaction record.

Through specific queries to the LLM, one or more embodiments are able to audit the millions of expenses of a target entity to perform, audit, and make corrections to carbon emission determination and characterization. Thus, the one or more embodiments facilitate an entity to stay in compliance with the GHG Protocol and subsequently develop energy efficiency measures to reduce emissions.

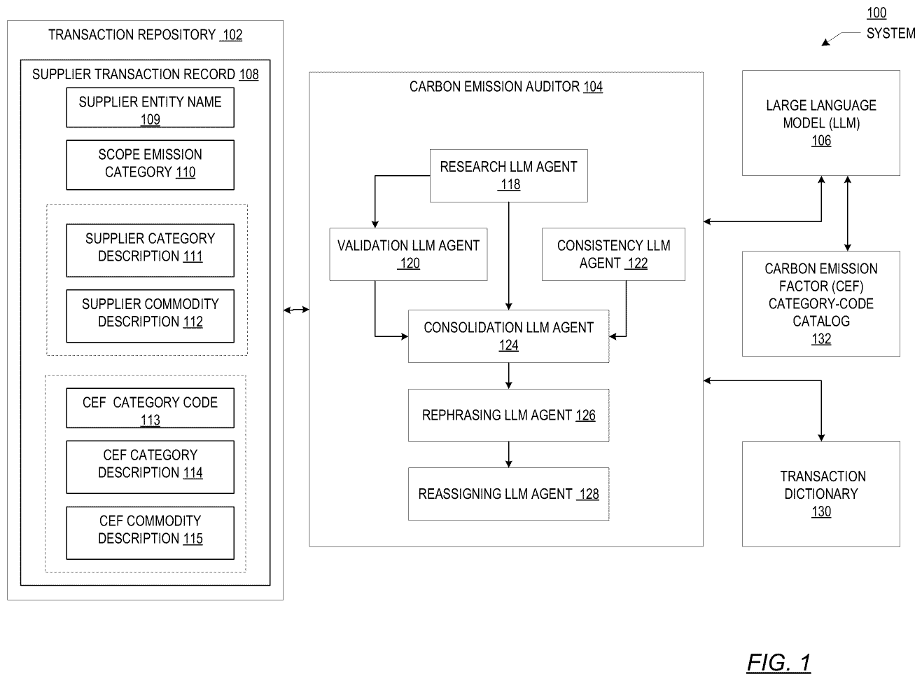

FIG. 1 is a diagram of an example system in accordance with one or more embodiments. As shown in FIG. 1, the system (100) includes transaction repository (102) connected to a carbon emission auditor (104). The carbon emission model is connected to a LLM (106).

LLMs are artificial neural network models that have millions or more parameters and are trained using self- or semi-supervised learning. For example, LLMs may be pre-trained models that are designed to recognize text, summarize the text, and generate content using very large datasets. LLMs are general models rather than specifically trained on a particular task. LLMs are not further trained to perform specific tasks. Further, LLMs are stateless models where each request is processed independently of other requests, even from the same user or session.

A transaction repository (102) is a repository for storing transaction records (e.g., supplier transaction record (108)) of a target entity. A transaction is an exchange or interaction between entities. Specifically, the transaction is an exchange between a target entity and an opposing entity. The opposing entity is the entity with which the transaction is performed. The target entity is the entity having the transaction records for which carbon emissions are being determined. The transaction record might be a financial transaction record and stores the costs, amount transacted, and other information. The transaction record may be a detailed transaction record and include specific information about one or more products (e.g., goods or services) transacted in the transaction. The transaction record might be a carbon emission record for a transaction. In such an example, a single transaction may have multiple carbon emission records, whereby each carbon emission record is for a specific product transacted. A specific type of transaction record is depicted in the system (100), namely, the supplier transaction record (108). Here, the opposing entity may be known as a supplier entity.

The supplier transaction record (108) includes a supplier entity name (109) of the supplier entity, and a scope emission category (110). The supplier entity name (109) is a unique identifier of the opposing entity. The supplier entity name (109) may be a registered name, a trade name (i.e., “doing business as” (DBA) name), or other name of the entity. The scope emission category (110) is a scope level and category of the GHG protocol, for example, “Scope 3, Category 4”. The supplier category description (111) and the supplier commodity description (112) are representative of one or more fields characterizing various aspects of a supplier category, for example, categories of products at various levels with which the supplier entity is associated.

The carbon emission factor (CEF) category code (113) is a category associated with carbon emissions. The CEF category code (113) may be hierarchically defined in a carbon emission factor database, shown as the carbon emission factor (CEF) category-code catalog (132) in FIG. 1. For example, the CEF category code (113) may be the category defined in the North American Industry Classification System (NAICS) and Comprehensive Environment (CEDA) databases. By way of an example of the hierarchy, the CEF category code (113) may be defined by a code for each of the sector, the subsector, the industry group, NAICS industry, and the national industry. If lower levels of the hierarchy (e.g., national industry, subsector) are not included, the emission factor is increased to accommodate the various possible emission factors of the whole category. Thus, not including specificity in the emission categorization leads to a higher emission factor. Corresponding to the CEF category code (113), the CEF category description (114) is a natural language description of the CEF category code (113).

The CEF commodity description (115) is a description of the commodity associated with the CEF category code (113). In one or more embodiments, the CEF commodity description (115) may be defined by the CEF category-code catalog (132). The CEF commodity description (115) is associated with the CEF category description (114). In an analogous manner to the record fields associated with a supplier, the CEF category description (114) and CEF commodity description (115) shown in FIG. 1 are representative of one or more record fields of the supplier transaction record having descriptions at various hierarchical levels of the CEF category code (113).

In one or more embodiments, one or more human operators may create the supplier transaction record (108). The one or more human operators may obtain a transaction record including the supplier-related fields (e.g., supplier category description (111), supplier commodity description (112), supplier entity name (109)). The one or more human operators may then work with the NAICS and CEDA databases, applying one or more conversion factor tables to obtain a CEF category code (113) and corresponding CEF category description (114) and CEF commodity description (115). Further, the aforementioned fields may be appended to the transaction record to obtain the supplier transaction record (108). Furthermore, the human operators may assign the scope emission category (110) based on the field values obtained from the CEF category-code catalog (132). These operations may be prone to errors, and consequently may necessitate an audit process.

Continuing with FIG. 1, the carbon emission factor (CEF) category-code catalog (132) is a catalog of databases accessible by the LLM (106) for reference. The LLM (106) may be pre-trained to interpret the codes of the respective databases included in the CEF category-code catalog (132). More specifically, the CEF category-code catalog (132) may include the NAICS and CEDA carbon emission factor databases.

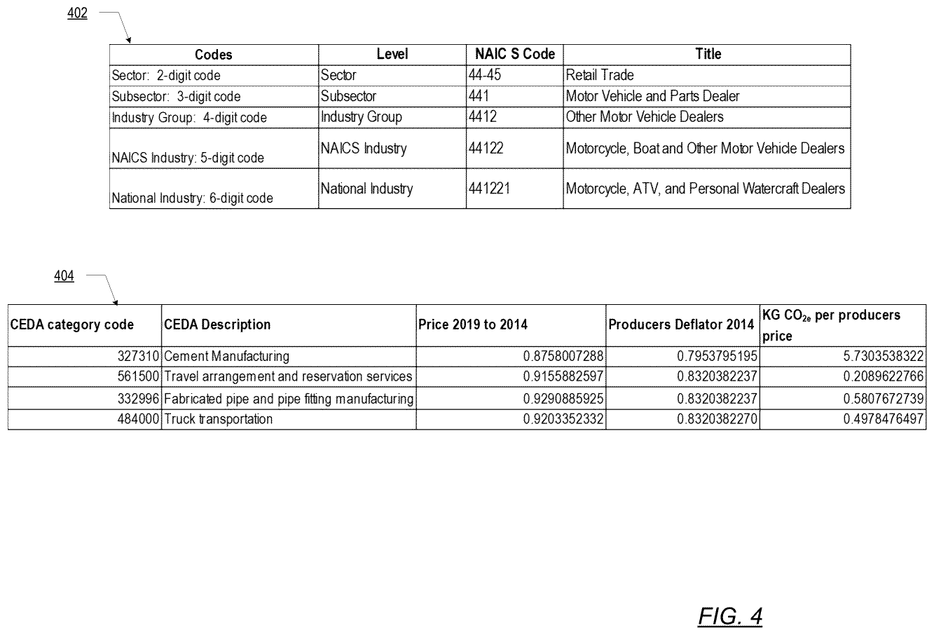

As a general overview, the Comprehensive Environmental Data Archive (CEDA), is a global database that provides Scope 3 carbon emissions data. The CEDA database is annually updated and accounts for the complexity of global production and trade. The CEDA is used by entities with global supply chains to code supplier transactions. The NAICS database (North American Industry Classification System) provides a coding standard to categorize and classify businesses based on their economic activities. Specifically, the NAICS-6 version defines industries at a detailed level using six-digit codes. A detailed example of the NAICS-6 coding system is provided in FIG. 4.

Continuing with FIG. 1, a carbon emission auditor (104) is a software system that is configured to perform carbon auditing for a target entity. For example, the carbon emission auditor (104) may include functionality to iterate through the transaction records in the transaction repository (102) and audit the carbon emission factors applied to the transaction records. The carbon emission auditor (104) includes a research LLM agent (118), a validation LLM agent (120), a consistency LLM agent (122), a consolidation LLM agent (124), a rephrasing LLM agent (126), and a reassigning LLM agent (128).

An LLM agent (e.g., the research LLM agent (118), the validation LLM agent (120), the consistency LLM agent (122), the consolidation LLM agent (124), the rephrasing LLM agent (126), the reassigning LLM agent (128)) is a collection of programs and code that uses an LLM as a central computational engine. The LLM agents use LLMs with the help of various tools and APIs (Application Programming Interfaces). The LLM agents may preserve context between successive interactions with an LLM. The LLM agents may create workflows of stepwise analyses of problems leading to responses of increased accuracy and pertinence to complex problems. The LLM agents may be specialized for a particular aspect or stage of problem solving (e.g., the research LLM agent is configured for retrieving up-to-date information on a supplier, the validation LLM agent is configured for validating CEF-related fields of the supplier transaction record against a research response from the research LLM agent). The LLM agents provide prompts to an LLM using the tools and APIs. A prompt refers to a natural language utterance including at least one of an instruction(s), example(s), and an input. The input may include instances of transaction records, user-generated information, etc. The LLM processes the input in accordance with the instruction of the prompt. The instruction(s) are specifically directed to the manner in which the LLM is to process the prompt. The examples may include one or more sample inputs and expected outputs. A prompt sent by an LLM agent that follows the same instructions and examples but with different input parameters is referred to as a parameterized prompt or templated prompt. Using templated prompts facilitates the re-use of a standard prompt structure while varying specific inputs to suit different contexts or tasks. Accordingly, each of the LLM agents of the carbon emission auditor (104) is described herein.

The research LLM agent (118) is configured to extract attributes of the supplier transaction record (108) and generate a prompt to the LLM (106) asking the LLM (106) to research the supplier entity. The researching LLM agent (118) may be configured to populate a predefined template with the entity name and entity category, and other information about the supplier entity.

The validation LLM agent (120) is configured to generate a prompt to the LLM (106) to determine whether the output of the researching LLM agent (118) is in the same field as the entity category and product description of the transaction record.

The consistency LLM agent (122) is configured to generate a prompt to the LLM (106), to determine whether the transaction record is internally consistent. For example, the consistency LLM agent (122) is configured to generate a natural language query using the attributes of the transaction record. The LLM (106) may then respond to the natural language query with whether the LLM (106) finds that the transaction record is internally consistent.

The consolidation LLM agent (124) is configured to consolidate the output of the research LLM agent (118), the validation LLM agent (120) and the consistency LLM agent (122) to determine whether the transaction record passes or fails an audit. Specifically, the consolidating LLM agent (124) may send a prompt with the output of the three LLM agents to the LLM (106). The consolidation LLM agent (124) is further configured to generate an audit pass or fail status based on the determination.

The rephrasing LLM agent (126) or the consolidation LLM agent (124) may be configured to provide a reason for the system (100) to fail the audit for the transaction record. Specifically, the rephrasing LLM agent (126) or consolidation LLM agent (124) may send a prompt to the LLM (106) asking for an explanation describing reasons for a transaction record to fail an audit.

The reassigning LLM agent (128) or the rephrasing LLM agent (126) may be configured to work with the LLM (106) to obtain a revised emission category and corresponding emission factor for the transaction record. In some cases, the reassigning LLM agent (128) is configured to determine the scope of the emission category.

The carbon emission auditor (104) may also include a graphical user interface (GUI) (not shown). The GUI may include functionality to highlight or otherwise demarcate transaction records that fail the audit. The GUI may further include functionality to present the natural language description from the rephrasing LLM agent (126) of why the audit failed and the suggested category from the reassigning unit.

As shown in FIG. 1, the various LLM agents of the carbon emission auditor (104) interact in a specific workflow. For example, the research LLM agent (118) is shown connected in a forward directional manner to the validation LLM agent (120) and the consolidation LLM agent (124). The research LLM agent (118) is additionally shown connected in a forward directional manner to the consistency LLM agent (122). The consolidation LLM agent (124) in turn is shown as connected to the rephrasing LLM agent (126) which in turn is shown as connected to reassigning LLM agent (128). This specific set of connections is representative of a “graph of thoughts” approach of interacting with the LLM (106). The “graph of thoughts” approach directs an LLM through a multi-stage, multi-context process, preserving the context of a previous prompt as an input or example to a next prompt.

Thus, the connections between the LLM agents shown in FIG. 1 are an example network of automated LLM agents that may perform the operations of the carbon emission auditor described above. The connections between the LLM agents shown in FIG. 1 depict an agentic workflow. An agentic workflow with respect to the LLM agents refers to a structured, multi-step process where multiple specialized AI agents collaborate to autonomously handle complex tasks.

The research LLM agent (118) is configured to research the supplier entity business to obtain a set of notes about the supplier entity. The validation LLM agent (120) obtains the information about the supplier entity to determine whether the supplier entity matches the emission category in the transaction record. The consistency LLM agent (122) determines whether the transaction record is internally consistent. For example, the inconsistency auditor may determine whether the emission category matches the type of product in the transaction.

The consolidation LLM agent (124) determines whether the audit passes or fails. The consolidation LLM agent (124) is used to catch inconsistency or confusion. The validation LLM agent (120) performs a first vote, the consistency LLM agent (122) performs a second vote, and the consolidation LLM agent (124) provides a final vote. The consolidation agent further generates an explanation of the reasons for the audit fail. The rephrasing LLM agent (126) is used when the audit fails. The rephrasing LLM agent (126) further provides the correct emission category, and emission factor. The reassigning LLM agent (128) may suggest a new scope and category of the spend for the transaction record if the audit fails.

In one or more implementations, additional interactions may take place (not shown) between the LLM agents of the carbon emission auditor (104).

The transaction dictionary (130) is a dictionary of previously audited supplier transaction records (108) by the carbon emission auditor (104). When the carbon emission auditor (104) is deployed in a work environment, the transaction dictionary (130) may be uninitialized, or empty. As the carbon emission auditor (104) processes successive supplier transaction records (108), the carbon emission auditor (104) logs the audited supplier transaction records (108) in the transaction dictionary (130).

In a work environment, successive application programming interface (API) calls to the LLM (106) by the various LLM agents may prove to be computationally expensive. Keeping a record of audited transactions may prevent redundant calls to the LLM (106). If a given supplier transaction record (108) obtained from the transaction repository (102) is matched with an existing supplier transaction record (108) in the transaction dictionary (130), then the existing supplier transaction record (108) is used. Specifically, if the fields of the given supplier transaction record (108) match the existing supplier transaction record (108) in the transaction dictionary (130), modifying the given supplier transaction record (108) fields (if suggested) may be duplicated from the existing supplier transaction record (108) copy in the transaction repository (102). Thus, as the transaction dictionary (130) stores repeated supplier transaction records (108), repeated calls to the LLM (106) by the LLM agents may be averted.

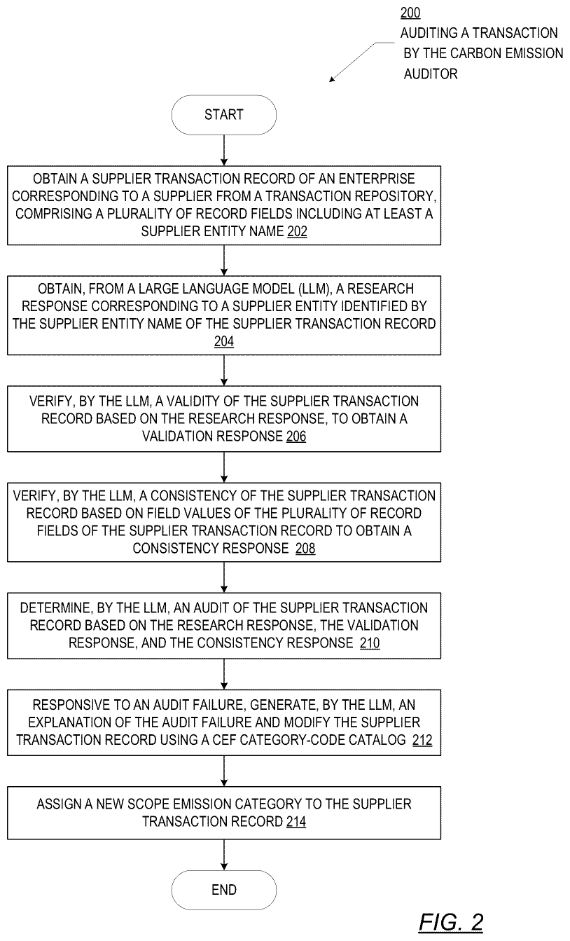

FIG. 2 is a flowchart for performing auditing in one or more embodiments. The method of FIG. 2 may be implemented using the system of FIG. 1, and one or more of the steps may be performed on or received at one or more computer processors. While the various steps in flowchart (200) are presented and described sequentially, at least some of the steps may be executed in different orders, may be combined, or omitted, and at least some of the steps may be executed in parallel. Furthermore, the steps may be performed actively or passively.

In Block 202, a supplier transaction record is obtained. The supplier transaction record includes multiple record fields, and the record fields include at least a supplier entity name. In one or more embodiments, the carbon emission auditor may extract the attributes of the supplier transaction record as a set of name-value pairs.

In Block 204, a research response corresponding to a supplier entity identified by the supplier entity name of the supplier transaction record is obtained. In one or more embodiments, the carbon emission auditor may utilize the research LLM agent to programmatically invoke the LLM, with a prompt. The prompt created by the research LLM agent may include an instruction to research the supplier entity by performing a search on the supplier entity name. The input of the prompt may include the supplier entity name. In one or more embodiments, an example response may be additionally provided in the prompt. The research LLM agent may use a templated prompt as a basis to generate the prompt. In one example, the templated prompt may define a sequence of steps that may be of the form shown:
“Action: Search
Action Input: TESORERIA DE LA FEDERACION
Observation: Tesoreria de lo Federacion (TESOFE). Unidad Administrativa de la SHCP encargado de la gestion financiera de los recursos y valores del Gobierno Federal.”
Action: Translate”.

The response obtained from the LLM may be of the form “Tesoreria de la Federacion (TESOFE) is a Mexican government financial management unit responsible for managing the resources and values of the Federal Government. Keywords: financial management, government resources.”

In Block 206, a validity of the supplier transaction record is verified by the LLM based on the research response, to obtain a validation response. In one or more embodiments, the carbon emission auditor deploys the validation LLM agent to programmatically invoke the LLM with a prompt. The prompt constructed by the validation LLM agent may include the research response, and an instruction to perform a validation analysis. Specifically, the instruction may include directions to validate the supplier transaction record by cross-checking CEF-related fields of the supplier transaction record with the research response. The prompt may further include the name-values of the CEF category code and CEF category description of the supplier transaction record as the input. Other record fields of the supplier transaction record may additionally be provided as input. The LLM may then cross-check the CEF category code and the corresponding CEF category description of the supplier transaction record against the research response. If the LLM determines that there is an inconsistency between the research response and at least one of the CEF category code and the CEF category response, the LLM may return information identifying the inconsistency and a validation result as “invalid.”

In one example, the prompt may be of the form:
“Question: Given SUPPLIER_ENTITY_NAME=SERVICIOS DE AUDITORIA Y, SUPPLIER_RESEARCH=Servicios de Auditoria y ofrece servicios de auditoria financiera, contable y de gestion para ayudar a los clientes a mejorar la CEDA_EMISSION_DESCRIPTION=Water transportation, HIER_DESCRIPTION=Technical Audits
does the CEDA Emission description semantically match the supplier research . . . ”

The LLM may respond in the form:
“Final_answer:
Audit_Pass: No
Two Step Justification:
#1: HIER_DESCRIPTION that is ‘Technical Audits’ is not related to CEDA_EMISSION_DESCRIPTION that is ‘Water transportation’ hence fail
#2: SUPPLIER_RESEARCH contents shows that Servicios de Auditoria y is in the business of providing financial, accounting and management audit services, it is not related to water transportation hence fail
# Overall: Invalid because #1 and #2 did not relate/did not match”

In the example, the validation response includes a validation result as “invalid.” The validation response further includes an explanation identifying at least one inconsistency between the research response and at least one of the CEF category codes, and the corresponding CEF category description. In one embodiment, if no inconsistency is identified, then the validation result may be “valid.”

In Block 208, the consistency of the supplier transaction record is verified by the LLM. The consistency of the supplier transaction record is checked based on field values of the multiple record fields to obtain a consistency response. In one or more embodiments, the carbon emission auditor may deploy the consistency LLM agent to programmatically invoke the LLM with a prompt. The prompt constructed by the consistency LLM agent may include an instruction to determine the internal consistency of the supplier transaction record between multiple record fields of the supplier transaction record. For example, the instruction may include directions to cross-check the supplier category description and supplier commodity description against the CEF category description and the CEF commodity description, respectively. Other fields may be included in the cross-check directions. In one or more embodiments, the inputs to the prompt may include at least the supplier transaction record, more particularly with at least the supplier category description, the supplier commodity description, the CEF category description, and CEF commodity description record fields.

If the LLM identifies at least one inconsistency between the supplier-related record fields and the CEF-related record fields, the consistency response may include at least one explanation identifying the at least one inconsistency and the specific record fields which are inconsistent in semantic meaning.

In one example, the prompt created by the consistency LLM agent may be of the form:
“Question: Now audit the following dictionary {‘CATEGORY’: ‘Manufacturing’, ‘ASL CATEGORY’: ‘Logistics’, ‘SUB_CATEGORY’: ‘Fabrication & Integration’, ‘FAMILY_DESCRIPTION’: ‘Atmospheric Storage’, ‘ASL SUB-CATEGORY’: ‘Freight shipping”

The LLM may return a response in the form:
“Final_answer:
#1: ‘CATEGORY’ that is ‘Manufacturing’ is not related to ‘ASL CATEGORY’ that is ‘Logistics’, hence invalid
#2: ‘ASL SUB-CATEGORY’ is ‘Freight Shipping’ but not clear why ‘CATEGORY’ is ‘Manufacturing’ and ‘SUB_CATEGORY’ is ‘Fabrication & Integration’ hence invalid
#3: ‘CAPABLE FAMILY’ that is ‘Warehousing Services’ is not related to any other expense field hence fail
# Overall: Audit_Fail because there is lot of ambiguity amongst several dictionary elements.

In Block 210, a determination is made by the LLM as to whether an audit of the supplier transaction record passes or fails. The audit is based on the LLM cross-checking the research response, the validation response, and the consistency response. In one or more embodiments, the carbon emission auditor may deploy the consolidation LLM agent to programmatically invoke the LLM with a prompt. The prompt constructed by the consolidation LLM agent may include at least the research response, the validation response, and the consistency response as input. The instruction of the prompt may include directions to determine the audit of the supplier transaction record based on the responses. More specifically, the instructions of the prompt may include directions to cross-check the responses. In one or more embodiments, the directions may further include the response which carries more weightage in determining which aspect of the supplier transaction record is incorrect. For example, the research response may have more weightage than the supplier category and supplier commodity description fields. These, in turn, may have more weightage than the CEF category code, CEF category description, and CEF commodity description fields. The LLM returns an audit result via the consolidation LLM agent. The audit result may be a “pass” or “fail” value, or an equivalent form or value thereof.

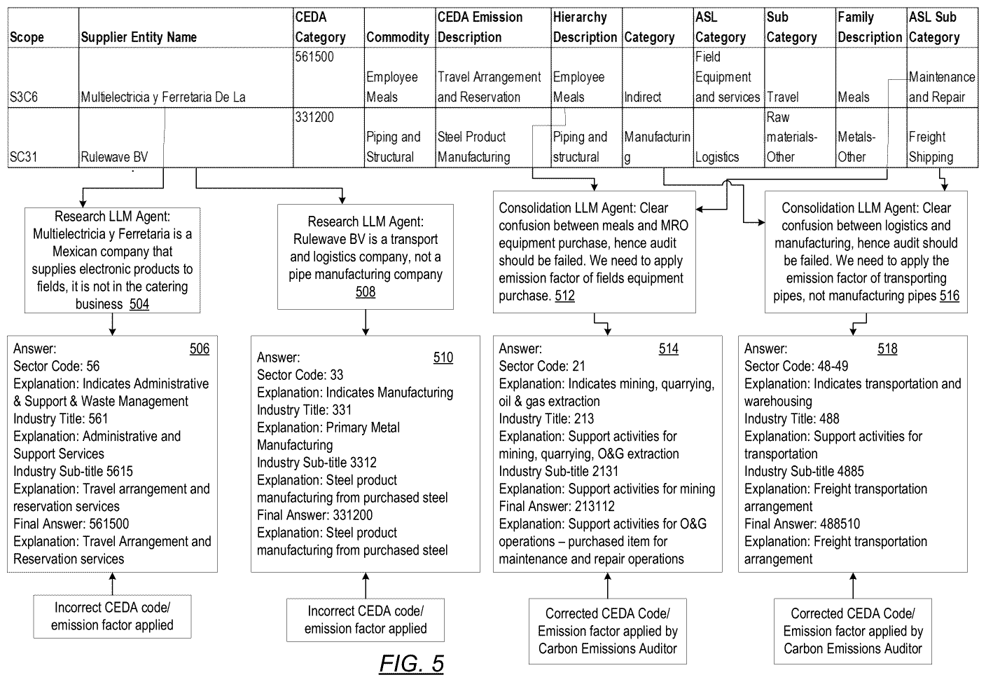

In Block 212, responsive to an audit failure, the LLM generates an explanation of the audit failing. Additionally, the supplier transaction record is modified, and a new scope emission category is assigned to the supplier transaction record. In one or more embodiments, the carbon emission auditor may deploy the rephrasing LLM agent to programmatically invoke the LLM with a prompt. The prompt constructed by the rephrasing LLM agent may include instructions to generate an explanation of the audit failure. Further, the rephrasing LLM agent may programmatically invoke the LLM to look up the CEF category-code catalog with information obtained from the research response, the validation response, and the consistency response. Based on this information, the LLM may then obtain at least a new CEF category code, a corresponding new CEF category description, and a new CEF commodity description from the CEF category-code catalog. The carbon emission auditor may further modify the supplier transaction record with at least the new CEF category code, the corresponding new CEF category description, and the new CEF commodity description. An example of the consolidation LLM agent output is shown in FIG. 5.

In Block 214, if the audit fails, a new scope emission category is generated for the supplier transaction record. In one or more embodiments, the carbon emission auditor may deploy the reassigning LLM agent to programmatically invoke the LLM with a prompt. The prompt constructed by the reassigning LLM agent may include instructions to obtain a GHG scope level and category matching the CEF-related fields of the modified supplier transaction record. The reassigning LLM agent may then modify the supplier transaction record by assigning a new scope emission category to the supplier transaction record. In one or more embodiments, a ledger may be created in the data repository and the modified version of the supplier transaction record may be added to the ledger. The original form of the supplier transaction record may be stored as is in the data repository.

An implementation goal of the carbon emission auditor is to optimize the number of programmatic calls made to the LLM. To this end, in one or more embodiments, prior to starting the agentic workflow beginning with the generation of the research response, the carbon emission auditor may store a copy of the supplier transaction record in a transaction dictionary. The transaction dictionary acts as a cache of supplier transaction records that are hitherto audited. A check is made before starting the agentic workflow to see if a given supplier transaction record matches any of the records in the transaction dictionary. If a matching supplier transaction record is found in the transaction dictionary, the implication is that an audit of the matching supplier transaction record is already performed. The audit results and applicable modifications of the matching supplier transaction record may be applied to the given supplier transaction record on account of their matching parameters. Thus, programmatic calls to the LLM and the agentic workflow may be averted. The given supplier transaction record obtained from the transaction repository may be modified in accordance with the modified copy (if applicable) of the matching supplier transaction record of the transaction dictionary. Notably, the modified copy of the matching supplier transaction record of the transaction dictionary, if available, may be found in the transaction repository.

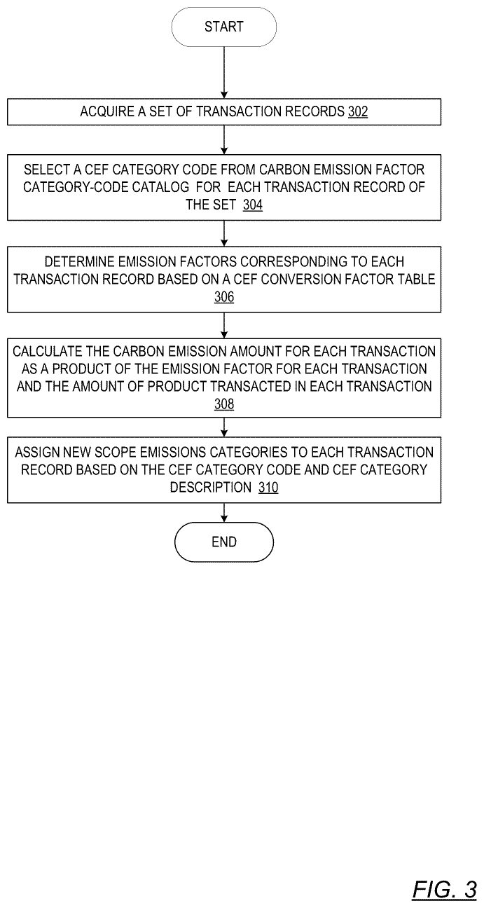

FIG. 3 shows a flowchart for a process of adding CEF category codes and corresponding CEF category description and CEF commodity description record fields to a transaction record containing supplier information to obtain supplier transaction records. The method of FIG. 3 may be implemented using the system of FIG. 1, and one or more of the steps may be performed on, or received at, one or more computer processors. While the various steps in flowchart 300 are presented and described sequentially, at least some of the steps may be executed in different orders, may be combined, or omitted, and at least some of the steps may be executed in parallel. Furthermore, the steps may be performed actively or passively.

In one or more embodiments, the carbon emission auditor may be deployed to add CEF category codes to transaction records of a target entity in the process of creating and populating the transaction repository with supplier transaction records. The carbon emission auditor uses the LLM agents in an agentic workflow to process the various fields of the transaction records of the target entity. The LLM agents may extract the semantic meaning of a record from the record fields of the record. The LLM agents may further cause the LLM to obtain an accurate mapping of a transaction record to a CEF category code based on the extracted semantic meaning of the transaction record.

In Block 302, a set of transaction records pertaining to a supplier entity is acquired. As the operations of a target entity are performed, the target entity generates millions of transaction records corresponding to various supplier entities to the target entity. The transaction records may include approved supplier list information, for example, supplier categories and subcategories (represented by the supplier category description shown in FIG. 1), supplier commodity information including commodity description, number of units purchased, etc.

In Block 304, a CEF category code is selected from the carbon emission factor category-code catalog for each transaction record of the set to determine the emission category. In one or more embodiments, the supplier category-related fields of the transaction records may be used to determine the CEF-category code and corresponding CEF-category description for the transaction record. Generally, the more specific emission category is a lower emission factor. Thus, the goal is to specifically define the emission category. Cross-checking the CEF category-code catalog against the transaction records may be performed by the components of the carbon emission auditor shown in FIG. 1. For example, the carbon emission auditor of FIG. 1 may be used to update existing emission factors and to suggest emission factors. In one or more embodiments, the carbon emission auditor may deploy the rephrasing LLM agent to programmatically invoke the LLM with a prompt. The prompt may include the supplier-category related fields of the transaction records and an instruction to search the CEF category-code catalog for a matching CEF category code. The rephrasing LLM agent may further populate at least a CEF category description corresponding to the CEF category code for each transaction record.

In Block 306, a CEF conversion factor table is applied to the transaction record to determine the emission factor to apply. The emission factor may then be multiplied by the amount of product transacted to determine the carbon emission amount. The CEF conversion factor table in the Comprehensive Environmental Data Archive (CEDA) database provides emission factors for various industrial sectors and regions. These factors are used to convert economic activity data into environmental impact data, such as greenhouse gas emissions. Emission factors are often expressed in units like kg CO2e per dollar of economic activity. An example of the emission factors is shown in FIG. 4.

In Block 308, the carbon emission amount for each transaction is calculated, as a product of the emission factor for each transaction and the amount of product transacted in each transaction. In one or more embodiments, the carbon emission auditor may perform the calculation step based on the emission factor obtained from the CEF conversion factor table.

In Block 310, a new scope emissions category is assigned to each transaction record based on the respective CEF category code and the respective CEF category description of each transaction record. In one or more embodiments, the carbon emission auditor may deploy the reassigning LLM agent to programmatically invoke the LLM with a prompt. The prompt may include at least the CEF category code and the CEF category description as input, and the instruction of the prompt may include directions to search the GHG protocol for descriptions matching the CEF category description and return a scope level and category type.

Further, the carbon emission auditor may add the augmented transaction record to the transaction repository as a new supplier transaction record.

FIG. 4 shows an example diagram of the emission category hierarchy. For example, in Block 402, for a motorcycle as shown in the table on the right, the six-digit code is 441221. The six-digit code encodes the national industry, the NAICS industry, the industry group, subsector, and sector. Block 404 shows an example portion of the CEDA database. For the emission categories, a corresponding emission factor exists. There is also an CEDA description (e.g., CEF category description in FIG. 1). The last column of the table of Block 404 is the carbon emission factor. The carbon emission factor may be multiplied by the spend value (e.g., amount spent) to obtain the carbon emission amount. The CEDA table has several of entries, which can be incorrectly applied. For example, if the target entity uses cement shipping and applies the code, 327310 (“cement manufacturing”), then the incorrect emission factor is applied.

FIG. 5 shows an example of a transaction record that has an incorrect CEDA code applied. In Block 504, “MULTIELECTRICIA Y FERRETARIA” is a Mexican company that supplies electronic products to fields; it is not in the catering business in contrast to the CEDA code 561500 having a commodity description of employee meals. Block 506 shows the breakdown of CEDA code 561500 and the corresponding description hierarchy. In Block 508, the second example of an incorrect transaction record shows “Rulewave BV” is a transport and logistics company, not into manufacturing of pipes as would be indicated by CEDA code 331200. The breakdown of CEDA code 331200 is shown in Block 508. In these examples, the research response invalidates the CEDA code. For example, the transportation of pipes has a much lower emission factor than the emission factor of manufacturing pipes. In Block 512, the audit conducted by the consolidation LLM agent fails and an explanation followed by an action is disclosed. In Block 514, the rephrasing LLM agent output is shown and a different CEDA code and corresponding description, now aligned with the research response is generated for the entity. Similarly, Blocks 516 and 518 show analogous outputs from the consolidation LLM agent and the rephrasing LLM agent for the second supplier entity.

By integrating LLM capabilities, the system adeptly navigates and inter-convert between complex emission factor tables like NAICS and CEDA, ensuring precise and reliable assessments. Leveraging the capability of LLMs as “few shot learners”, meaning that LLMs can imitate a specific type of desired response given a few diverse examples, prevents the system from downtime required for conventional natural language processing re-training. Further, if the real-world data undergoes a change or deviation, the prompts to the LLM generated by the LLM agents may be modified, and no code changes may be necessitated. The implementation of machine-driven carbon auditing significantly reduces the burden of manual efforts and saves valuable time, enabling businesses and individuals to swiftly access comprehensive emission analyses without compromising on accuracy or reliability. This novel technology helps consumers to make environmentally conscious choices, and lets companies achieve their goals of a more sustainable future.

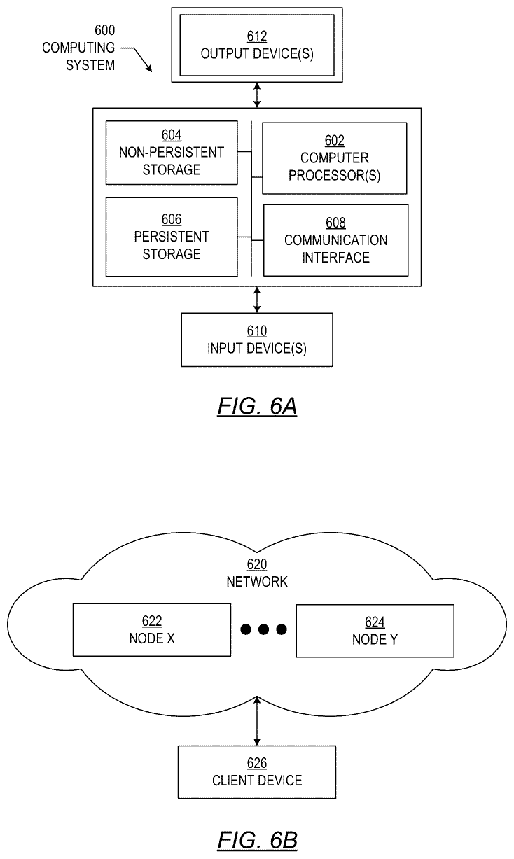

Embodiments may be implemented on a computing system specifically designed to achieve an improved technological result. When implemented in a computing system, the features and elements of the disclosure provide a technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 6A, the computing system (600) may include one or more computer processors (602), non-persistent storage (604), persistent storage (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores or micro-cores of a processor. The computer processor(s) (602) includes one or more processors. The one or more processors may include a central processing LLM agent (CPU), a graphics processing LLM agent (GPU), a tensor processing unit (TPU), combinations thereof, etc.

The input devices (610) may include a touchscreen, keyboard, mouse, microphone, touchpad, electronic pen, or any other type of input device. The input devices (610) may receive inputs from a user that are responsive to data and messages presented by the output devices (612). The inputs may include text input, audio input, video input, etc., which may be processed and transmitted by the computing system (600) in accordance with the disclosure. The communication interface (608) may include an integrated circuit for connecting the computing system (600) to a network (not shown) (e.g., a local area network (LAN), a wide area network (WAN) such as the Internet, mobile network, or any other type of network) and/or to another device, such as another computing device.

Further, the output devices (612) may include a display device, a printer, external storage, or any other output device. One or more of the output devices (612) may be the same or different from the input device(s) (610). The input (610) and output device(s) (612) may be locally or remotely connected to the computer processor(s) (602). Many diverse types of computing systems (600) exist, and the aforementioned input (610) and output device(s) (612) may take other forms. The output devices (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (600) in FIG. 6A may be connected to or be a part of a network. For example, as shown in FIG. 6B, the network (620) may include multiple nodes (e.g., node X (622) and node Y (624)). Each node may correspond to a computing system, such as the computing system (600) shown in FIG. 6A, or a group of nodes combined may correspond to the computing system (600) shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626), including receiving requests and transmitting responses to the client device (626). For example, the nodes may be part of a cloud computing system. The client device (626) may be a computing system, such as the computing system (600) shown in FIG. 6A. Further, the client device (626) may include and/or perform at least a portion of one or more embodiments.

The computing system (600) of FIG. 6A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining a supplier transaction record of an enterprise corresponding to a supplier from a transaction repository, comprising a plurality of record fields including at least a supplier entity name;
obtaining, from a large language model (LLM), a research response corresponding to a supplier entity identified by the supplier entity name of the supplier transaction record;
verifying, by the LLM, a validity of the supplier transaction record based on the research response, to obtain a validation response;
verifying, by the LLM, a consistency of the supplier transaction record based on field values of the plurality of record fields of the supplier transaction record to obtain a consistency response;
determining, by the LLM, an audit of the supplier transaction record based on the research response, the validation response, and the consistency response; and
responsive to an audit failure,
generating, by the LLM, an explanation of the audit failure,
modifying the supplier transaction record, and
assigning a new scope emission category to the supplier transaction record.

2. The method of claim 1, further comprising:
obtaining the research response by:
constructing a prompt to the LLM by a research LLM agent, wherein the prompt includes at least the supplier entity name, and an instruction to perform a search on the supplier entity name.

3. The method of claim 1, further comprising:
verifying, by the LLM the validity of the supplier transaction record by:
constructing a prompt to the LLM by a validation LLM agent, wherein the prompt includes at least the research response, the supplier transaction record, and an instruction to perform a validation analysis; and
obtaining the validation response from the LLM including at least a validation result, and at least one explanation identifying at least one inconsistency between the research response and at least one of a CEF category code, and a corresponding CEF category description of the supplier transaction record.

4. The method of claim 1, further comprising:
verifying, by the LLM, the consistency of the supplier transaction record by:
constructing a prompt to the LLM by a consistency LLM agent, wherein the prompt includes at least the supplier transaction record and an instruction to determine an internal consistency of the supplier transaction record between the plurality of record fields of the supplier transaction record, wherein the plurality of record fields includes at least a supplier category description, a supplier commodity description, a CEF category description, and a CEF commodity description; and
responsive to at least one inconsistency being identified by the LLM, obtaining the consistency response from the LLM including at least one explanation identifying the at least one inconsistency between the plurality of record fields of the supplier transaction record.

5. The method of claim 1, further comprising:
determining, by the LLM, the audit of the supplier transaction record by:
constructing a prompt to the LLM by a consolidation LLM agent, wherein the prompt includes an input having at least the research response, the validation response, the consistency response, and an instruction to determine the audit of the supplier transaction record based on the input to obtain an audit result, and returning the audit result.

6. The method of claim 1 further comprising:
responsive to the audit failure,
constructing a prompt to the LLM by a rephrasing LLM agent wherein the prompt includes an instruction to generate the explanation of the audit failure,
obtaining, by the LLM, via the rephrasing LLM agent, at least a new CEF category code, a corresponding new CEF category description and a new CEF commodity description from a CEF category-code catalog, based on the research response, the validation response, and the consistency response, and
modifying the supplier transaction record with at least the new CEF category code, the corresponding new CEF category description and the new CEF commodity description.

7. The method of claim 1, further comprising:
responsive to the audit failure,
assigning, by the LLM, via a reassigning LLM agent, the new scope emission category to the supplier transaction record.

8. The method of claim 1, further comprising:
adding the supplier transaction record to a transaction dictionary, prior to obtaining the research response.

9. The method of claim 1, further comprising:
prior to obtaining the research response, checking a transaction dictionary for a matching supplier transaction record matching the supplier transaction record obtained from the transaction repository; and
responsive to finding the matching supplier transaction record in the transaction dictionary,
modifying the supplier transaction record obtained from the transaction repository based on a modified copy of the supplier transaction record obtained from the transaction dictionary, wherein the modified copy is stored in the transaction repository.

10. A system comprising:
at least one computer processor;
a transaction repository;
a large language model (LLM) executing on the at least one computer processor; and
a carbon emission auditor, executing on the at least one computer processor and configured to:
obtain a supplier transaction record of an enterprise corresponding to a supplier from the transaction repository, comprising a plurality of record fields including at least a supplier entity name,
obtain, from the LLM executing on the at least one computer processor, a research response corresponding to a supplier entity identified by the supplier entity name of the supplier transaction record,
cause the LLM executing on the at least one computer processor to verify a validity of the supplier transaction record based on the research response, to obtain a validation response,
cause the LLM executing on the at least one computer processor to verify a consistency of the supplier transaction record based on field values of the plurality of record fields of the supplier transaction record to obtain a consistency response,
cause the LLM executing on the at least one computer processor to determine an audit of the supplier transaction record based on the research response, the validation response, and the consistency response; and
responsive to an audit failure,
cause the LLM executing on the at least one computer processor to generate an explanation of the audit failure,
modify the supplier transaction record, and
assign a new scope emission category to the supplier transaction record.

11. The system of claim 10, wherein the carbon emission auditor is further configured to:
obtain the research response by constructing a prompt to the LLM by a research LLM agent, wherein the prompt includes at least the supplier entity name, and an instruction to perform a search on the supplier entity name.

12. The system of claim 10, wherein the carbon emission auditor is further configured to:
cause the LLM executing on the at least one computer processor to verify the validity of the supplier transaction record by:
deploying a validation LLM agent to construct a prompt to the LLM, wherein the prompt includes at least the research response, the supplier transaction record, and an instruction to perform a validation analysis; and
obtain the validation response from the LLM including at least a validation result, and at least one explanation identifying at least one inconsistency between the research response and at least one of a CEF category code, and a corresponding CEF category description of the supplier transaction record.

13. The system of claim 10, wherein the carbon emission auditor is further configured to:
cause the LLM executing on the at least one computer processor to verify the consistency of the supplier transaction record by:
deploying a consistency LLM agent to construct a prompt to the LLM,
wherein the prompt includes at least the supplier transaction record and an instruction to determine an internal consistency of the supplier transaction record between the plurality of record fields of the supplier transaction record, wherein the plurality of record fields includes at least a supplier category description, a supplier commodity description, a CEF category description, and a CEF commodity description; and
responsive to at least one inconsistency being identified by the LLM, obtaining via the consistency LLM agent, the consistency response from the LLM including at least one explanation identifying the at least one inconsistency between the plurality of record fields of the supplier transaction record.

14. The system of claim 10, wherein the carbon emission auditor is further configured to:
cause the LLM executing on the at least one computer processor to determine the audit of the supplier transaction record by:
deploying a consolidation LLM agent to construct a prompt to the LLM,
wherein the prompt includes an input having at least the research response, the validation response, the consistency response, and an instruction to determine the audit of the supplier transaction record based on the input to obtain an audit result, and
to return the audit result.

15. The system of claim 10 wherein:
responsive to the audit failure, the carbon emission auditor is further configured to:
deploy a rephrasing LLM agent to construct a prompt to the LLM wherein the prompt includes an instruction to generate the explanation of the audit failure,
obtain, from the LLM, via the rephrasing LLM agent, at least a new CEF category code, a corresponding new CEF category description and a new CEF commodity description from a CEF category-code catalog, based on the research response, the validation response, and the consistency response, and
modify the supplier transaction record with at least the new CEF category code, the corresponding new CEF category description and the new CEF commodity description.

16. The system of claim 10, wherein:
responsive to the audit failure, the carbon emission auditor is further configured to:
deploy a reassigning LLM agent to:
obtain the new scope emission category from the LLM, and
assign the new scope emission category to the supplier transaction record.

17. The system of claim 10, wherein the carbon emission auditor is further configured to:
add the supplier transaction record to a transaction dictionary, prior to obtaining the research response.

18. The system of claim 10, wherein the carbon emission auditor is further configured to:
check a transaction dictionary for a matching supplier transaction record matching the supplier transaction record obtained from the transaction repository, prior to obtaining the research response; and
responsive to finding the matching supplier transaction record in the transaction dictionary,
modify the supplier transaction record obtained from the transaction repository based on a modified copy of the supplier transaction record obtained from the transaction dictionary, wherein the modified copy is stored in the transaction repository.

19. A method comprising:
acquiring, by a carbon emission auditor, a set of transaction records pertaining to a supplier entity;
selecting, by an LLM, via a rephrasing LLM agent, a carbon emission factor (CEF) category code from a CEF category-code catalog for each transaction record of the set of transaction records;
populating, by the rephrasing LLM agent, each transaction record of the set of transaction records with a respective CEF category description corresponding to a respective CEF category code of each transaction record;
determining, by the LLM via the rephrasing LLM agent, emission factors corresponding to each transaction record of the set of transaction records based on a CEF conversion factor table in the CEF category-code catalog; and
calculating a carbon emission amount for each transaction record of the set of transaction records as a product of an emission factor for each transaction record and an amount of product transacted from each transaction record.

20. The method of claim 19, further comprising:
assigning, by the LLM, via a reassigning LLM agent, a new scope emissions category for each transaction record of the set of transaction records, based on a CEF category code and a corresponding CEF category description of each transaction record of the set of transaction records.
